(19) United States
(12) Patent Application Publication
(10) Pub. No.: US 2010/0251387 A1
(43) Pub. Date: Sep. 30, 2010

(54) TERMINAL APPARATUS, DATA PROVIDING SYSTEM, DATA PROVIDING METHOD, AND COMPUTER PROGRAM

(75) Inventors: Iori TAKEDA, Kagawa (JP); Kei TAKAGI, Kagawa (JP); Hitoshi KAMURA, Kagawa (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/687,313

(22) Filed: Jan. 14, 2010

(30) Foreign Application Priority Data
Mar. 27, 2009 (JP) 2009-080397

(51) Int. Cl. G06F 17/30; G06F 21/22; G06F 1/26; G06F 15/16

(52) U.S. Cl. 726/29; 707/674; 713/310; 709/203; 707/E17.005

(57) ABSTRACT

A terminal apparatus includes requester that requests data used for installed software from an external apparatus, a receiver that receives the data requested by the requester, a storage unit that stores the data received by the receiver, a restoring unit that restores the storage unit to the state at an arbitrary point of time; and a restoration controller that enables or disables the restoration operation of the restoring unit, wherein the storage unit stores the data that is requested by the requester and received by the receiver after the restoration controller disables the restoration operation of the restoring unit, the restoration controller enables the restoration operation of the restoring unit after the data received by the receiver is stored in the storage unit, and the restoring unit restores the storing unit to the state at a point of time when or after the restoration controller enables the restoration operation.

### CROSS-REFERENCE TO RELATED APPLICATIONS

This application is related to and claims priority to Japanese Patent Application No. 2009-80397 filed on Mar. 27, 2009 and herein incorporated by reference.

### BACKGROUND

1. Field

The embodiments discussed herein are directed to a terminal apparatus, a data providing system, a data providing method, and a computer program capable of preventing stored necessary data from being deleted when stored contents are restored.

2. Description of the Related Art

In recent years, software is readily copied since personal computers (hereinafter referred to as PCs) have been widely used and sophisticated, resulting in illegal software distribution.

To prevent illegal use of software, a license authentication system in which software in question is checked to see whether it is a legitimate product has been proposed.

In this system, a software-driven PC cannot use software unless the license thereof has been legitimately acquired (purchased).

More specifically, the PC manually or automatically communicates with an authentication server installed by a manufacturer of software in question via a network and acquires and stores an authentication key issued from an authentication server.

The software can be executed in the PC as long as the PC stores an authentication key.

Conventionally, a license authentication system in which the software is, for example, an operation system (OS) for operating a PC or restoration software capable of restoring accidentally deleted data is proposed (Japanese Patent Laid-Open No. 2007-58266, for example).

### SUMMARY

It is an aspect of the embodiments discussed herein to provide a terminal apparatus including a requester that requests data used for installed software from an external apparatus-, a receiver that receives the data requested by the requester, a storage unit that stores the data received by the receiver, a restoring unit that restores the storage unit to the state at an arbitrary point of time-, and a restoration controller that enables or disables the restoration operation of the restoring unit, wherein the storage unit stores the data that is requested by the requester and received by the receiver after the restoration controller disables the restoration operation of the restoring unit, the restoration controller enables the restoration operation of the restoring unit after the data received by the receiver is stored in the storage unit, and the restoring unit restores the storing unit to the state at a point of time when or after the restoration controller enables the restoration operation.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates a data providing system according to a first exemplary embodiment.

FIG. 2 illustrates an authentication server.

FIG. 3 illustrates an exemplary data structure of an authentication key.

FIG. 4 illustrates a configurations of an administration apparatus and a PC.

FIG. 5 illustrates an exemplary data providing system.

FIG. 6 illustrates exemplary processes carried out by an administration apparatus;

FIG. 7 illustrates exemplary processes carried out by an authentication server;

FIG. 8 illustrates exemplary processes to be carried out by each PC;

FIG. 9 illustrates a data providing system according to a second exemplary embodiment;

FIG. 10 illustrates exemplary processes to be carried out by an administration apparatus;

FIG. 11 illustrates exemplary processes to be carried out by an administration apparatus;

FIG. 12 illustrates exemplary processes to be carried out by an administration apparatus;

FIG. 13 illustrates exemplary processes to be carried out by an administration apparatus; and

FIG. 14 illustrates exemplary processes to be carried out by a PC.

### DETAILED DESCRIPTION OF THE EMBODIMENTS

PCs located, for example, in a school or what is called an Internet cafe, and connected to a network are under circumstances where the settings of the PCs are changed or files are added or deleted by users.

Therefore, an administrator needs to initialize the PCs after they have been used.

To alleviate this task, there is a software product having a function of restoring, for example, stored contents to the state at a certain point of time.

The product can restart the PCs all together via a network on a regular basis, for example, in a midnight time frame and restore, for example, the settings.

When the license authentication system described above is used in an environment in which the product described above is used, each of the PCs that has acquired and stored an authentication key could be disadvantageously brought back to the state before the key was stored.

As a result, software could not be used, because the PC is brought back to the state before the license of the software was acquired.

According to an aspect of an exemplary embodiment, storage can be restored without a fear that data necessary to execute software may be deleted.

According to another aspect of an exemplary embodiment, the restoration operation may be disabled when data is requested from a server. In this way, received, stored data will not be deleted in the restoration operation.

According to another aspect of an exemplary embodiment, the restoration operation can be enabled after the data have been received, and in the following restoration operation, the storage can be restored to the state at a point of time when or after the restoration operation is enabled. In this way, stored necessary data will not be deleted.

Exemplary embodiments of a data providing system and a data providing method are disclosed.

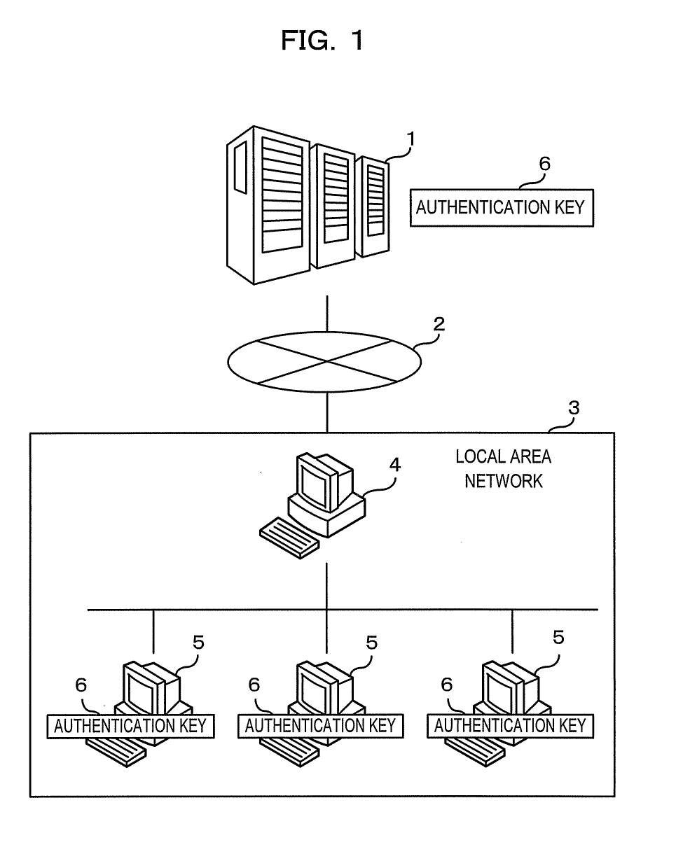

FIG. 1 illustrates a data providing system according to a first exemplary embodiment.

The data providing system includes an authentication server 1, a communication network 2, and a local area network 3 that is connected to an authentication server 1 via the communication network 2.

The communication network 2 may be a wired communication network, such as the Internet, or a wireless communication line, such as a mobile telephone network and a terrestrial digital broadcasting network.

The local area network 3 is built, for example, in a school, a company, and an Internet cafe.

The local area network 3 includes a plurality of personal computers (hereinafter referred to as PCs) 5 capable of sending and receiving data to and from an authentication server 1 via the communication network 2, and an administration apparatus 4 that administers the PCs 5.

An administration apparatus 4 and the PCs 5 are connected to one another in a wired or wireless manner so that data can be sent and received to and from one another.

An administration apparatus 4 can send data to each of the PCs 5 and remotely control the functions of the PC 5.

For example, each of the PCs 5 is capable of restoring.

The restoring is capable of resetting the contents stored in the PC 5 or the settings thereof on a regular basis to the state at an arbitrary point of time.

Even when a user installs software in any of the PCs 5 or changes the settings (environment) thereof without acquiring permission to do so from an administrator, the restoring can bring the PC 5 back to the state before the change was made on a regular basis.

An administration apparatus 4 switches the state of the restoring between an enabled state and a disabled state.

After an administration apparatus 4 disables the restoring, it is no longer active. In this case, even when the stored contents or the settings of the PC 5 are changed, the PC 5 will not be brought back to the state before the change was made.

When the stored contents or the settings are changed during the period when the restoring is disabled, the stored contents and other data will not be restored even after the restoring is enabled again.

Each of the PCs 5 is capable of turning on and off its power source in response to a signal transmitted from an administration apparatus 4.

Even when the power source of the PC 5 is off, electric power is supplied to part of the circuit boards in the PC 5 so that the signal can be received.

An administration apparatus 4 can transmit a power activation signal to any of the PCs 5 that has been turned off to turn on that PC.

In this way, an administration apparatus 4 can turn on any of the PCs 5 in a time frame when the PC is not in use (midnight time frame, for example) and remotely control the PC 5.

Further, any of the PCs 5 that has been turned on is turned off when it receives a power disconnection signal from an administration apparatus 4.

Software, such as an OS (Operating System) that requires license authentication, is installed in each of the PCs 5 disclosed in the present application.

An OS that requires license authentication is executable when the PC 5 is assigned a license, for example, from the manufacturer that sells the OS.

The PC 5 can be assigned a license when the PC 5 receives an authentication key 6 stored in an authentication server 1 via the communication network 2.

An authentication server 1 is a server included in the data providing system disclosed in the present application and stores an authentication key 6 described above.

An authentication server 1 transmits an authentication key 6 in an encrypted form to any of the PCs 5 in response to a request from the PC 5.

The PC 5 that has received an authentication key 6 decrypts and stores it.

The PC 5 that stores an authentication key 6 can execute the OS.

An authentication key 6 is effective for a certain period (180 days, for example). When (or before) the effective period expires, the PC 5 sends a license authentication request again to an authentication server 1.

It is noted that the PC 5 may undergoes license authentication when it receives a command from an administration apparatus 4 or when the PC 5 itself judges that it should do so.

It is assumed in the description that the license authentication is performed in response to a command from an administration apparatus 4.

An authentication server 1, an administration apparatus 4, and the PCs 5 described above may be connected to one another in a wired or wireless manner.

The communication environment is not limited to a LAN (Local Area Network) or a WAN (Wide Area Network).

Further, the software to be installed in the PCs 5 may alternatively be computer virus disinfection software.

In this case, the PCs 5 request a virus pattern from an authentication server 1.

The configurations of an authentication server 1, an administration apparatus 4, and the PCs 5 included in the data providing system will next be described in detail.

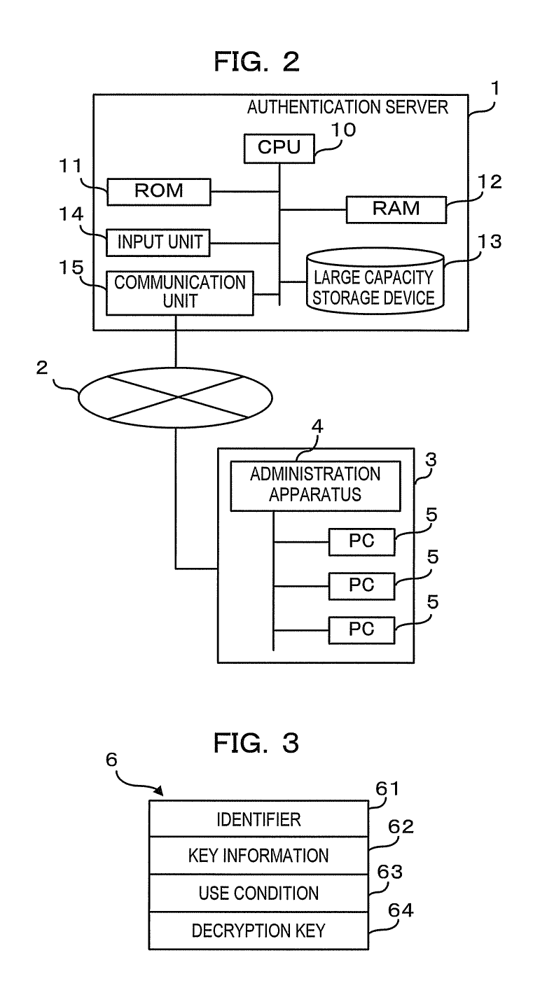

FIG. 2 illustrates a configuration of an authentication server 1.

An authentication server 1 includes a CPU (Central Processing Unit) 10, a ROM (Read Only Memory) 11, a RAM (Random Access Memory) 12, a large capacity storage device 13, an input unit 14, a communication unit 15, and other hardware portions.

The hardware portions described above are connected to one another via a bus.

The input unit 14 is, for example, a mouse and a keyboard.

The communication unit 15 is, for example, a modem that allows data communication with the PCs 5 and other components.

The CPU 10 reads a control program held, for example, in the ROM 11 in advance, places the program in the RAM 12 as appropriate, and executes the program to control the operation of each of the hardware portions described above.

The ROM 11 holds in advance a variety of control programs necessary to operate an authentication server 1 as a server disclosed in the present application.

The RAM 12 is, for example, an SRAM (Static RAM), a DRAM (Dynamic RAM), or a flash memory.

The RAM 12 temporarily stores a variety of data produced when the CPU 10 executes any of the control programs.

The large capacity storage device 13 is, for example, a hard disk drive (hereinafter referred to as an HDD).

The large capacity storage device 13 stores an authentication key 6 corresponding to the software installed in the PCs 5.

An authentication server 1 encrypts an authentication key 6 stored in the large capacity storage device 13 and transmits the encrypted authentication key 6 to the PC 5 that requests license authentication.

FIG. 3 illustrates an example of the data structure of an authentication key 6.

An authentication key 6 includes an identifier 61, key information 62, a use condition 63, and a decryption key 64.

The identifier 61 is information added to identify an authentication key 6.

The key information 62 is information on the corresponding content or provider.

The use condition 63 contains, for example, the effective period (180 days, for example) during which the software in question can be used.

The decryption key 64 is a key for decrypting the encrypted authentication key 6.

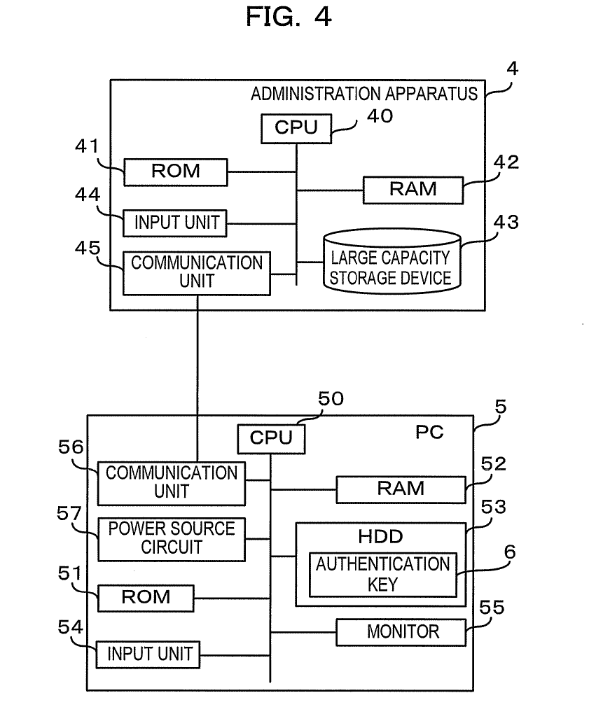

FIG. 4 illustrates a configurations of an administration apparatus 4 and each of the PCs 5.

An administration apparatus 4 includes a CPU 40, a ROM 41, a RAM 42, a large capacity storage device 43, an input unit 44, a communication unit 45, and other hardware portions.

The hardware portions described above are connected to one another via a bus.

The communication unit 45 allows data communication with the PCs 5 and an authentication server 1.

The CPU 40 reads a control program held, for example, in the ROM 41 in advance, places the program in the RAM 42 as appropriate, and executes the program to control the operation of each of the hardware portions described above.

The ROM 41 holds in advance a variety of control programs necessary to operate an administration apparatus 4 as a restoration control apparatus disclosed in the present application.

The RAM 42 is, for example, an SRAM, a DRAM, or a flash memory.

The RAM 42 temporarily stores a variety of data produced when the CPU 40 executes any of the control programs.

The large capacity storage device 43 is, for example, an HDD.

The large capacity storage device 43 holds, for example, commands having been issued to the PCs 5.

Each of the PCs 5 includes a CPU 50, a ROM 51, a RAM 52, an HDD 53, an input unit 54, a monitor 55, a communication unit 56, a power source circuit 57 capable of switching, and other hardware portions.

The hardware portions described above are connected to one another via a bus.

The communication unit 56 allows data communication with an authentication server 1 and an administration apparatus 4.

The monitor 55 is, for example, a liquid crystal display or a CRT (Cathode Ray Tube) display.

The input unit 54 is, for example, a mouse and a keyboard.

The CPU 50 reads a control program held, for example, in the ROM 51 in advance, places the program in the RAM 52 as appropriate, and executes the program to control the operation of each of the hardware portions described above.

The ROM 51 holds in advance a variety of control programs necessary to operate each of the PCs 5 as a terminal apparatus disclosed in the present application.

The RAM 52 is, for example, an SRAM, a DRAM, or a flash memory.

The RAM 52 temporarily stores a variety of data produced when the CPU 50 executes any of the control programs.

The HDD 53 has a plurality of storage areas, such as a secure area where secret data are stored and a storage area where software is stored.

The HDD 53 stores an authentication key 6 in the secure area and the OS described above and other software in the storage area, which differs from the secure area.

A user cannot access the secure area.

When the PC 5 is turned on, the CPU 50 activates the OS.

At this point, when an authentication key 6 is stored in the secure area of the HDD 53, or when the effective period of an authentication key 6 is not expired, the OS is executed.

The power source circuit 57 is a circuit that controls the power source of the corresponding PC 5.

When the PC 5 is turned on or off, the power source circuit 57 supplies electric power to the CPU 50 and other components or stops supplying electric power. The PC 5 thus becomes active or inactive.

Even when the power source is off, electric power is supplied to the power source circuit 57, whereby the power source circuit 57 and the communication unit 56 are active.

Therefore, the communication unit 56 can receive a signal from an administration apparatus 4 even when the power source is off.

When the power source is OFF and the communication unit 56 receives the power activation signal from an administration apparatus 4, the power source circuit 57 switches the state of the power source from OFF to ON.

When the power source is ON and the communication unit 56 receives the power disconnection signal from an administration apparatus 4, the power source circuit 57 switches the state of the power source from ON to OFF.

Exemplary operations performed by an authentication server 1, an administration apparatus 4, and the PCs 5 in executing respective control programs are disclosed.

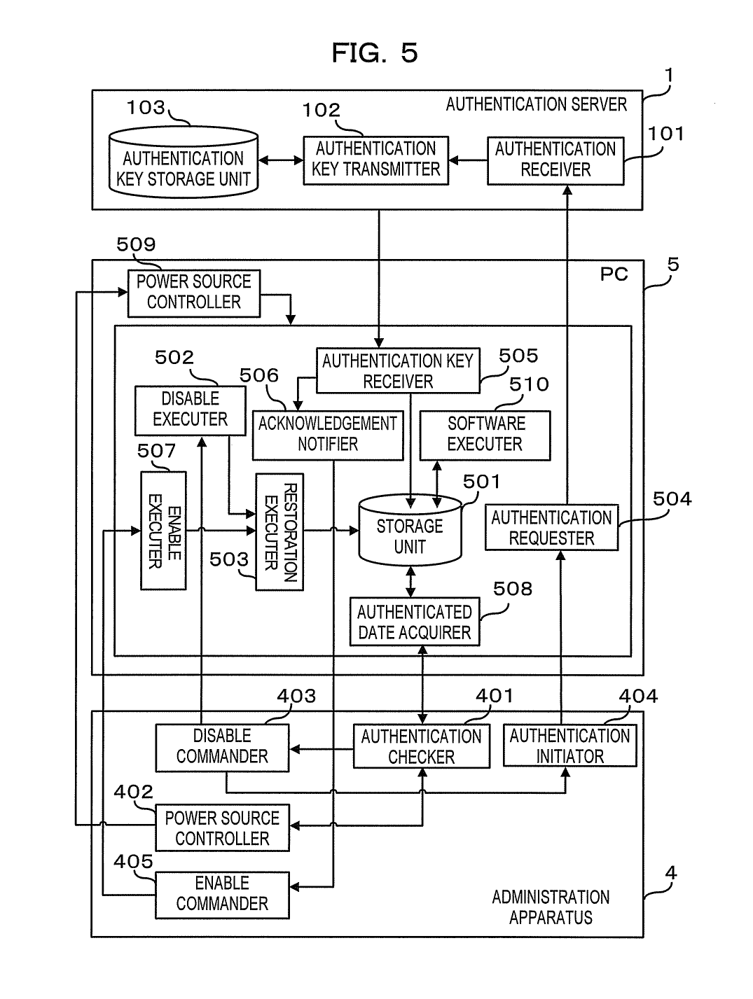

FIG. 5 illustrates a data providing system.

An authentication server 1 has an authentication receiver 101, an authentication key transmitter 102 capable of transmitting data, and an authentication key storage unit 103.

An administration apparatus 4 includes an authentication checker 401, a power source controller 402, a disable commander 403 capable of disabling signal transmitting, an authentication initiator 404, and an enable commander 405

Each of the PCs 5 includes a storage unit 501, a disable executer 502, a restoration executer 503, an authentication requester 504, an authentication key receiver 505, an acknowledgement notifier 506 capable of judging a necessity, an enable executer 507, an authenticated date acquirer 508, a power source controller 509 capable of switching, and external signal receiving, and a software executer 510.

An authentication checker 401 of an administration apparatus 4 initiates inquiry, for example, when a fixed period has elapsed, about the authenticated date when the PCs 5 underwent license authentication.

To this end, the power source controller 402 transmits the power activation signal to the PCs 5.

The power source controller 509 of each of the PCs 5 that has received the power activation signal turns on the power source of the PC 5.

The PCs 5 thus become active.

An authentication checker 401 transmits an inquiry signal to the authenticated date acquirer 508 of each of the PCs 5 when the power source controller 402 turns on the power source of the PC 5.

The authenticated date acquirer 508 acquires the date when an authentication key 6 stored in the storage unit 501 was acquired (hereinafter referred to as an authenticated date) and transmits the authenticated date to an authentication checker 401 of an administration apparatus 4.

An authentication checker 401 instructs the PCs 5 to request license authentication when the time that has elapsed since the acquired authenticated date is longer than the effective period of an authentication key 6.

The judgment based on the authenticated date may alternatively be made in the PCs 5.

The disable commander 403 commands each of the PCs 5 to disable the restoring.

The disable executer 502 of each of the PCs 5 receives the command from the disable commander 403 and disables the restoring performed by the restoration executer 503.

After the disable commander 403 has disabled the restoring, an authentication initiator 404 of an administration apparatus 4 instructs the PCs 5 to request license authentication.

An authentication requester 504 of each of the PCs 5 receives the instruction from an authentication initiator 404 and sends a license authentication request to an authentication server 1.

An authentication receiver 101 receives the license authentication request, and an authentication key transmitter 102 acquires an authentication key 6 corresponding to the received request from an authentication key storage unit 103.

An authentication key transmitter 102 encrypts an authentication key 6 and transmits it to the PCs 5.

An authentication key receiver 505 of each of the PCs 5 receives an authentication key 6 from an authentication server 1, decrypts an authentication key 6, and stores it in the storage unit 501.

The acknowledgement notifier 506, after an authentication key 6 has been received, judges whether it is necessary to resume the restoring. When it is necessary to resume the restoring, the acknowledgement notifier 506 notifies an administration apparatus 4 of an acknowledgement of an authentication key 6.

The acknowledgement notifier 506 judges that it is not necessary to resume the restoring, for example, when a process other than license authentication needs to be carried out.

The enable commander 405, when notified of the acknowledgement, commands the each of the PCs 5 to enable the restoring thereof.

The enable executer 507 of each of the PCs 5 enables the restoring performed by the restoration executer 503.

After the enable commander 405 has completed the enabling operation, the power source controller 402 transmits the power disconnection signal to the PCs 5.

The power source controller 509 of each of the PCs 5 that has received the power disconnection signal turns off the power source of the PC 5.

The restoration executer 503 of each of the PCs 5, when the power source of the PC 5 is ON, deletes the contents stored in not only the storage area but also the secure area of the storage unit 501 (HDD 53) described above whenever a given period (8 hours, for example) has elapsed.

In this process, the restoration executer 503 does not delete the contents that were stored in the storage unit 501 during the period from the time when the disable executer 502 disabled the restoring to the time when the enable executer 507 enabled the restoring (hereinafter referred to as a disabled period).

For example, the restoration executer 503 restores the contents except those at the addresses of the storage unit 501 where data have been stored during the disabled period.

In this way, an authentication key 6 acquired in the disabled period and stored in the storage unit 501 will not be deleted by the restoration executer 503.

The software executer 510 executes the OS stored in the storage unit 501.

The software executer 510 checks whether an authentication key 6 is stored in the storage unit 501 and executes the OS when an authentication key 6 is stored in the storage unit 501.

The operations of an authentication server 1, an administration apparatus 4, and the PCs 5 included in the data providing system will be described below.

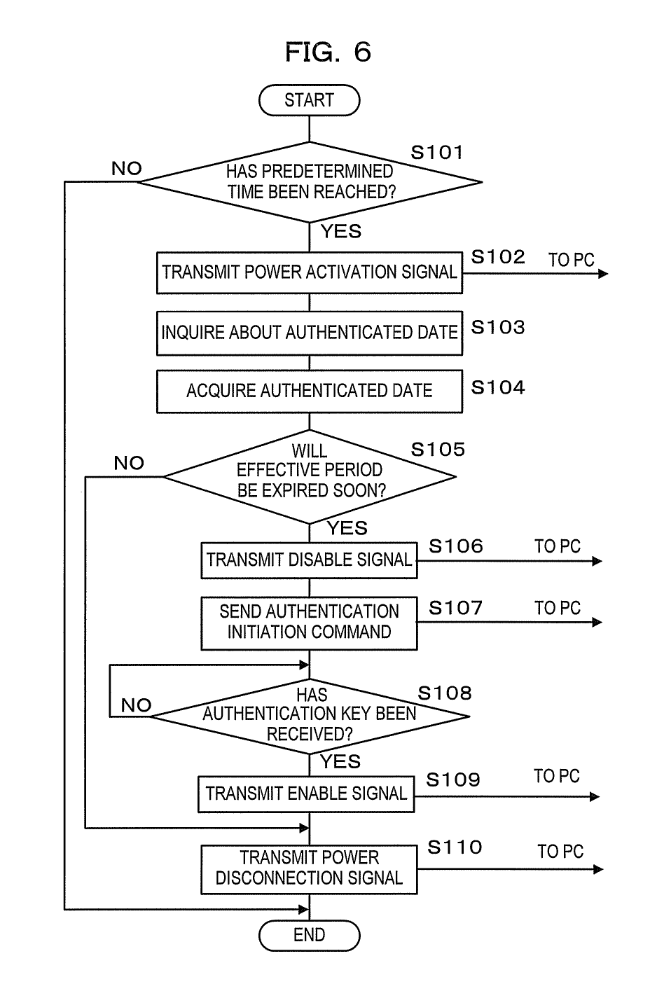

FIG. 6 illustrates exemplary processes carried out by an administration apparatus 4.

The following processes are carried out by the CPU 40 in accordance with the control programs held in the ROM 41 in an administration apparatus 4.

The CPU 40 judges whether a given time has been reached (S101).

The given time used herein is, for example, a midnight time frame during which the PCs 5 are not in use.

When the given time has not been reached (S101: NO), the CPU 40 judges that a time frame when the PCs 5 undergo license authentication has not been reached and terminates the processes.

When the given time has been reached (S101: YES), the CPU 40 transmits the power activation signal to the PCs 5 (S102).

The CPU 40 can start the inactive PCs 5 by transmitting the power activation signal.

The CPU 40, after having transmitted the power activation signal and turned on each of the PCs 5, inquires about the authenticated date (S103) and acquires the authenticated date from the PC 5 (S104).

When the authenticated date cannot be acquired, the CPU 40 may issue an error.

An administration apparatus 4 may store the authenticated date when the PCs 5 connected to an administration apparatus 4 have undergone license authentication.

In this case, an administration apparatus 4 does not need to inquire of the PCs 5 about the authenticated date or start the inactive PCs 5.

The CPU 40 judges whether a given period has elapsed since the acquired authenticated date to judge whether an authentication key 6 will be soon expired (S105).

For example, when the effective period starts from the authenticated date and lasts for 180 days and 170 days have elapsed since the acquired authenticated date, the CPU 40 judges that an authentication key 6 will be soon expired.

When the CPU 40 judges that the effective period will not be soon expired (S105: NO), the CPU 40 judges that the PCs 5 do not need to undergo license authentication and transmits the power disconnection signal (S110).

In this way, the PCs 5 having been turned on are turned off again.

The CPU 40 then terminates the processes.

When the CPU 40 judges that the effective period will be soon expired (S105: YES), the CPU 40 transmits a disable signal that disables the restoring to the PCs 5 (S106).

In the PCs 5 that have received the disable signal, the restoring is disabled.

The CPU 40 then instructs the PCs 5 to initiate license authentication (S107).

The CPU 40 judges whether the PCs 5 have received an authentication key 6 from an authentication server 1 (S108).

The CPU 40 makes the above judgment, for example, when the PCs 5 that have received an authentication key 6 notify the CPU 40.

When an authentication key 6 has not been received (S108: NO), the CPU 40 waits until an authentication key 6 is received.

In this process, when an authentication key 6 has not been received even after a given period has elapsed, the processes may be terminated and an error may be issued.

When the PCs 5 have received an authentication key 6 (S108: YES), the CPU 40 transmits to the PCs 5 an enable signal that enables the disabled restoring (S109).

The CPU 40 then transmits the power disconnection signal to the PCs 5 (S110).

The PCs 5 are thus turned off.

The CPU 40 then terminates the processes.

The maintenance of each of the PCs 5 is readily carried out by turning the PC 5 on at midnight and instructing the PC 5 to undergo necessary license authentication in accordance with the processes illustrated in FIG. 6.

Further, temporarily disabling the restoring of each of the PCs 5 during the period when the license authentication is performed can prevent the acquired authentication key 6 acquired by the PC 5 from being deleted in the restoration process.

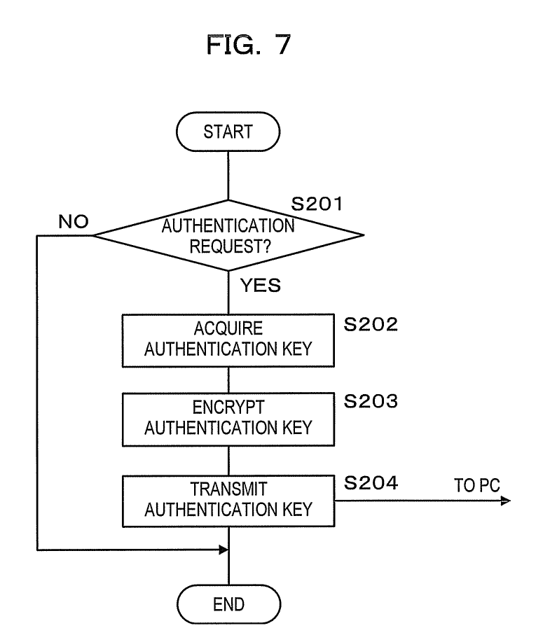

FIG. 7 illustrates exemplary processes carried out by an authentication server 1.

The following processes are carried out by the CPU 10 in accordance with the control programs held in the ROM 11 in an authentication server 1.

The CPU 10 judges whether it has received a license authentication request from each of the PCs 5 (S201).

When the CPU 10 has not received any request (S201: NO), the CPU 10 terminates the processes.

When the CPU 10 has received a license authentication request (S201: YES), the CPU 10 acquires the corresponding authentication key 6 from the large capacity storage device 13 (S202) and encrypts an authentication key 6 (S203).

The CPU 10 transmits the encrypted authentication key 6 to the PCs 5 (S204) and terminates the processes.

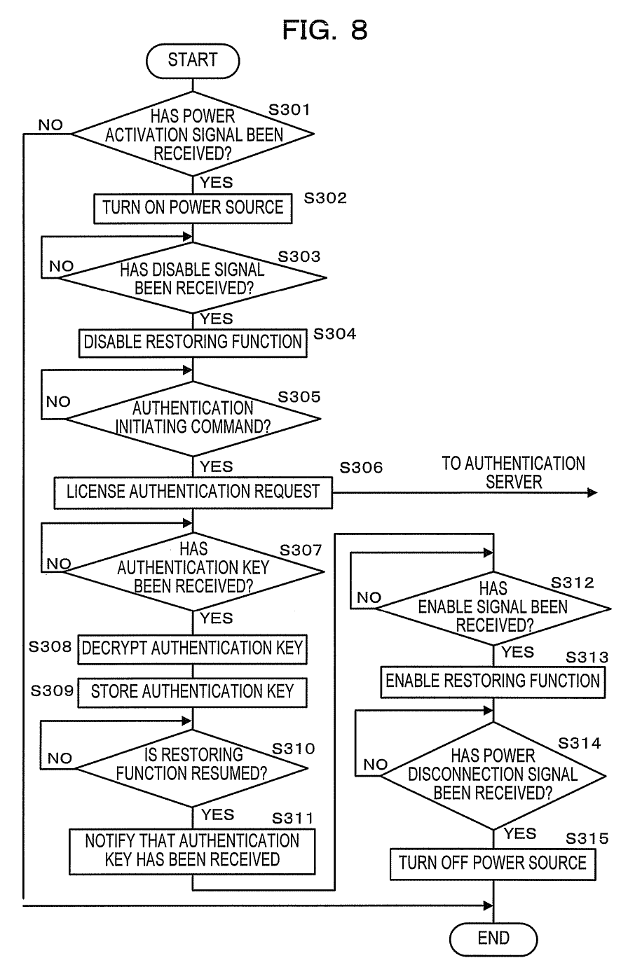

FIG. 8 illustrates exemplary processes to be carried out by each of the PCs 5.

The following processes are carried out by the power source circuit 57 and the CPU 50 in the PC 5. The CPU 50 carries out the processes in accordance with the control programs held in the ROM 51.

It is noted that the power source of the PC 5 is OFF when the processes illustrated in FIG. 8 are initiated.

The power source circuit 57, which is active even when the power source is OFF, judges whether it has received the power activation signal from an administration apparatus 4 (S301).

When no power activation signal has been received (S301: NO), the processes are terminated.

When the power activation signal has been received (S301: YES), the power source circuit 57 turns on the power source (S302).

The CPU 50 and other components in the PC 5 thus become active.

The CPU 50, which is now active, judges whether it has received the disable signal from an administration apparatus 4 (S303).

When no disable signal has been received (S303: NO), the CPU 50 waits until it receives the disable signal.

In this process, when no disable signal is received for a given period, the CPU 50 may judge that an error has occurred and carry out an error process.

When the disable signal has been received (S303: YES), the CPU 50 disables the restoring (S304).

Once the restoring is disabled, the contents stored in the HDD 53 will not be deleted in the restoration process.

When the CPU 50 has disabled the restoring, the CPU 50 may notify an administration apparatus 4 that the restoring has been disabled.

The CPU 50 then judges whether it has received a license authentication request initiating command from an administration apparatus 4 (S305).

When no initiating command has been received (S305: NO), the CPU 50 waits until it receives the initiating command.

When the initiating command has been received (S305: YES) the CPU 50 sends a license authentication request to an authentication server 1 (S306).

An authentication server 1 then encrypts the corresponding authentication key 6 and transmits it to the PC 5.

The CPU 50 judges whether an authentication key 6 has been received from an authentication server 1 (S307).

When an authentication key 6 has been received (S307: YES), the CPU 50 decrypts the received authentication key 6 (S308) and stores it (S309).

As a result, the CPU 50 can be assigned a license of the installed software (OS) and execute the software.

The CPU 50 judges whether the restoring should be presumed (S310).

The CPU 50 judges that the restoring should not be resumed when a process other than the license authentication needs to be carried out.

When the restoring is not resumed (S310: NO), the CPU 50 waits until it judges that the restoring should be resumed.

When the restoring is resumed (S310: YES), the CPU 50 notifies an administration apparatus 4 that an authentication key 6 has been received (S311).

An administration apparatus 4, when notified that an authentication key 6 has been received, carries out a restoring enabling process and transmits the enable signal.

The CPU 50 judges whether the enable signal has been received from an administration apparatus 4 (S312).

When no enable signal has been received (S312: NO), the CPU 50 waits until the enable signal is received.

When the enable signal has been received (S312: YES), the CPU 50 enables the restoring (S313).

When the restoring has been enabled, the CPU 50 may notify an administration apparatus 4 that the restoring has been enabled.

In the restoration process, the CPU 50 restores the contents except those stored in the HDD 53 during the period from the time when the restoring was disabled in S304 to the time when the restoring was enabled in S313.

That is, an authentication key 6 received from an authentication server 1 will not be deleted even when the restoration process is carried out.

The license authentication performed by the CPU 50 thus remains valid.

After the license authentication has been completed, the power source circuit 57 of each of the PCs 5 judges whether the power disconnection signal has been received from an administration apparatus 4 (S314).

When no power disconnection signal has been received (S314: NO), the power source circuit 57 waits until it receives the power disconnection signal.

When the power disconnection signal has been received (S314: YES), the power source circuit 57 turns off the power source (S315).

The CPU 50 and other components in the PC 5 thus become inactive. The processes are then terminated.

A data providing system according to a second embodiment will be described below.

In the second embodiment, the configurations that are similar as those of the data providing system according to the first embodiment described above have the same reference characters, and a detailed description of those configurations is not repeated.

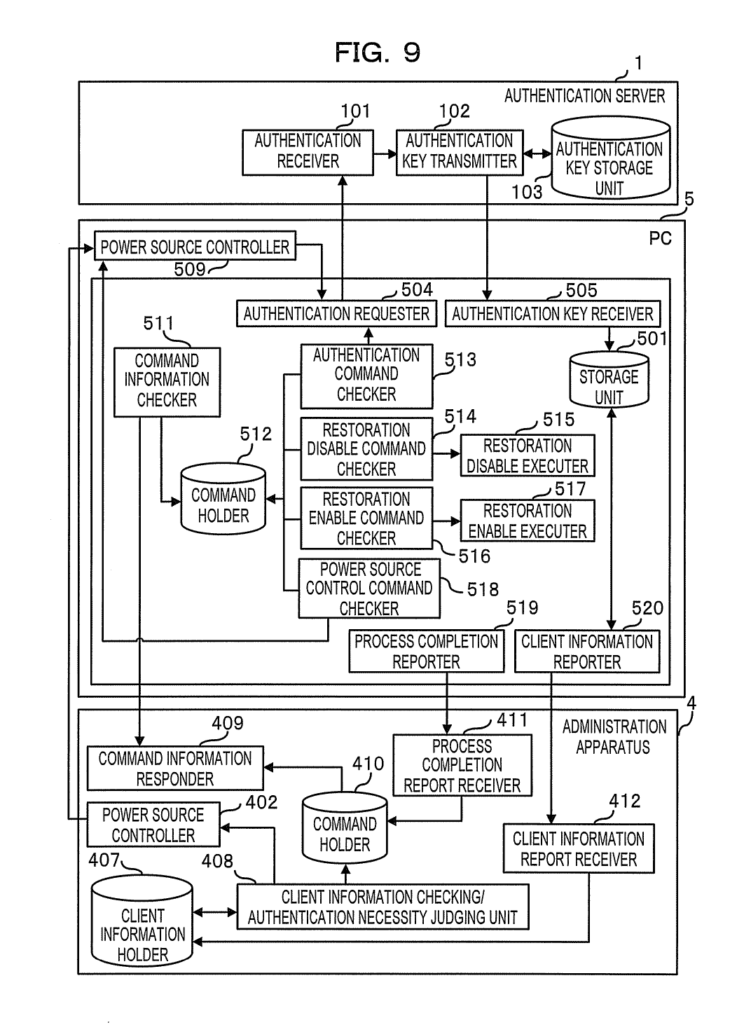

FIG. 9 illustrates a functions of the data providing system according to the second embodiment.

An authentication server 1 of the second embodiment also has an authentication receiver 101, an authentication key transmitter 102, an authentication key storage unit 103, and other functions, as in the first embodiment.

An administration apparatus 4 of the second embodiment has the power source controller 402, a client information holder 407, a client information checking/authentication necessity judging unit 408, a command information responder 409, a command holder 410, a process completion report receiver 411, a client information report receiver 412, and other functions.

Each of the PCs 5 has the storage unit 501, an authentication requester 504, an authentication key receiver 505, the power source controller 509, a command information checker 511, a command holder 512, an authentication command checker 513, a restoration disable command checker 514, a restoration disable executer 515, a restoration enable command checker 516, a restoration enable executer 517, a power source control command checker 518, a process completion reporter 519, a client information reporter 520, and other functions.

The client information reporter 520 of each of the PCs 5 regularly uploads the client information on the PC 5 to the client information report receiver 412 of an administration apparatus 4, which then saves the client information in the client information holder 407.

The client information is used to judge whether the PC 5 needs to be authenticated, and includes the authenticated date when the license authentication was performed.

The client information checking/authentication necessity judging unit 408 refers to the client information saved in the client information holder 407 and judges whether the PC 5 requires license authentication.

When the client information checking/authentication necessity judging unit 408 judges that authentication is required, the power source controller 402 transmits the power activation signal to the PC 5.

When the client information checking/authentication necessity judging unit 408 judges that authentication is required, a variety of commands are held in the command holder 410, such as a command for disabling the restoring of the PC 5, a command for performing license authentication, a command for enabling the restoring, and a command for controlling the power source of the PC 5.

The commands held in the command holder 410 are ready to be transmitted to the PC 5.

The command information checker 511 of the PC 5 inquires of an administration apparatus 4 whether it has any command to be executed by the PC 5.

The command information responder 409, when it has received the inquiry from the PC 5, transmits a command ready to be transmitted and held in the command holder 410, if any, to the PC 5.

The transmitted command is held in the command holder 512 of the PC 5.

An authentication command checker 513, the restoration disable command checker 514, the restoration enable command checker 516, and the power source control command checker 518 check the commands held in the command holder 512 and execute them.

For example, the restoration disable command checker 514 instructs the restoration disable executer 515 to disable the restoring, whereas the restoration enable command checker 516 instructs the restoration enable executer 517 to enable the restoring.

The power source control command checker 518 instructs the power source controller 509 to turn off the power source.

The process completion reporter 519 of the PC 5 reports to the process completion report receiver 411 of an administration apparatus 4 that the license authentication and other processes have been completed.

The process completion report receiver 411, when having received the report, stores the fact that the PC 5 has completed the commands that an administration apparatus 4 has judged necessary for license authentication.

The process completion report receiver 411 makes sure that no command is left in the command holder 410 when the command information checker 511 of the PC 5 next inquires about a command.

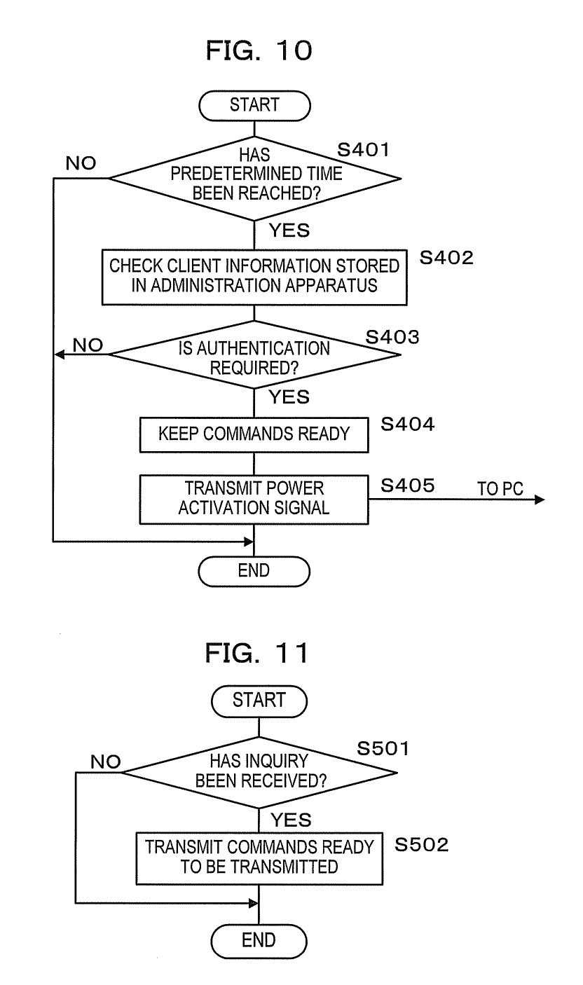

FIGS. 10, 11, 12, and 13 are flowcharts illustrating processes to be carried out by an administration apparatus 4.

The following processes are carried out by the CPU 40 in accordance with the control programs held in the ROM 41 in an administration apparatus 4.

FIG. 10 illustrates processes to be carried out by the CPU 40 when it judges whether any of the PCs 5 needs to undergo license authentication.

The CPU 40 judges whether a given time has been reached (S401).

The given time used herein is, for example, a midnight time frame during which the PC 5 in question is not in use.

When the given time has not been reached (S401: NO), the CPU 40 judges that a time frame when the PC 5 undergoes license authentication has not reached and terminates the processes.

When the given time has been reached (S401: YES), the CPU 40 checks the client information stored in an administration apparatus 4 (S402) and judges whether the PC 5 needs to undergo license authentication (S403).

When the CPU 40 judges that no license authentication is required (S403: NO), the CPU 40 terminates the processes.

When the CPU 40 judges that license authentication is required (S403: YES), for example, because a given period has elapsed since the last date when license authentication was performed, the CPU 40 keeps several commands ready to be transmitted to the PC 5 where they are executed (S404).

The CPU 40 then transmits the power activation signal to the PC 5 (S405), and starts the inactive PC 5.

The CPU 40 then terminates the processes.

FIG. 11 illustrates processes to be carried out by the CPU 40 when the command information checker 511 of the PC 5 described above inquires of the CPU 40 about the commands to be executed by the PC 5.

The CPU 40 judges whether the PC 5 inquires of the CPU 40 about commands (S501).

When no inquiry has been received (S501: NO), the CPU 40 terminates the processes.

When the inquiry has been received (S501: YES), the CPU 40 transmits the several commands (S502) made ready in 5404 in FIG. 10 to the PC 5 and terminates the processes.

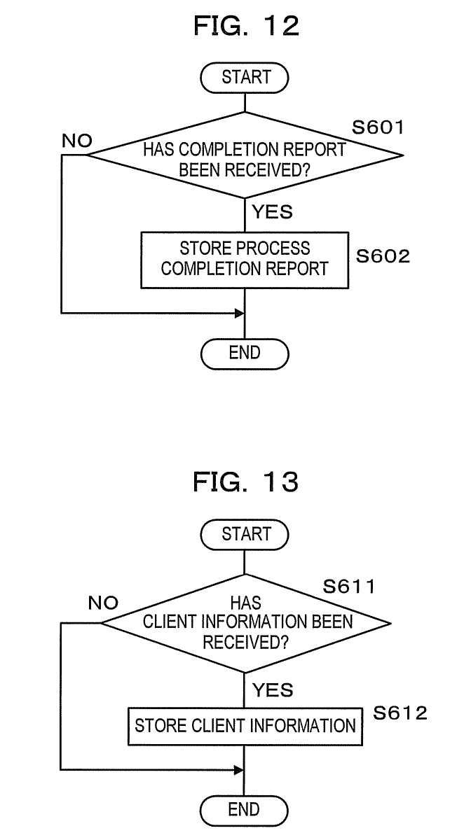

FIG. 12 illustrates processes to be carried out by the CPU 40 when it is notified by the PC 5 that the license authentication has been completed.

The CPU 40 judges whether it has received from the PC 5 a report of the completion of the license authentication (S601).

When no report has been received (S601: NO), the CPU 40 terminates the processes.

When the report has been received (S601: YES), the CPU 40 stores the report of the completion of the process (S602) and terminates the processes.

FIG. 13 illustrates processes to be carried out by the CPU 40 when the PC 5 has updated the client information.

The CPU 40 judges whether it has received client information from the PC 5 (S611).

When no client information has been received (S611: NO), the CPU 40 terminates the processes.

When client information has been received (S611: YES), the CPU 40 stores the received client information (S612) and terminates the processes.

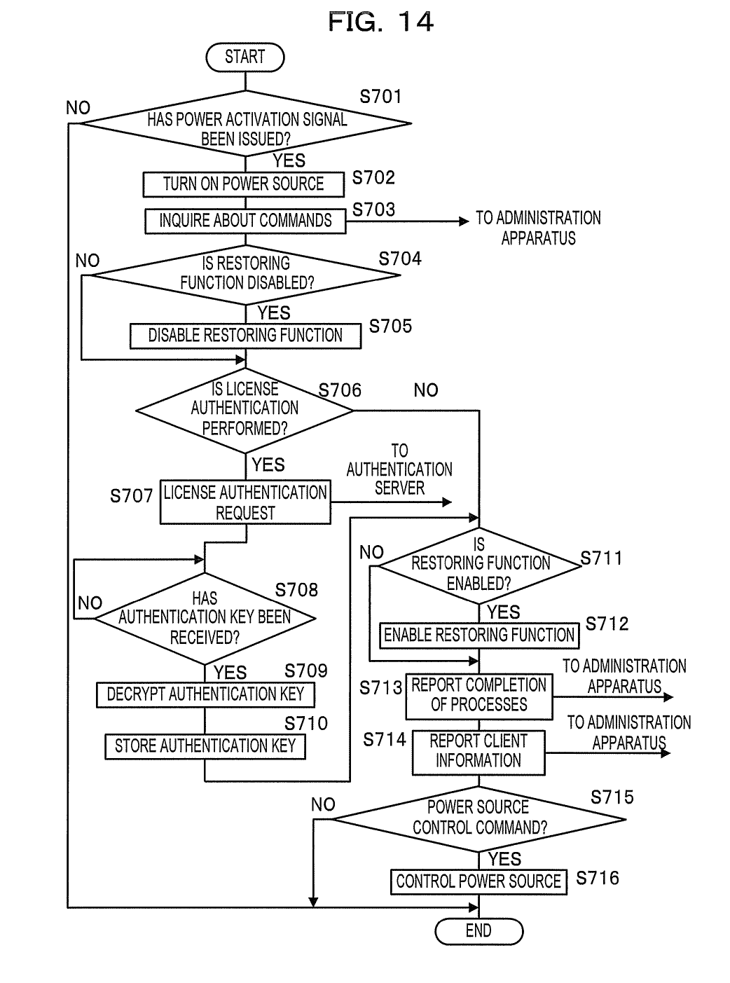

FIG. 14 illustrates exemplary processes to be carried out by the PC 5.

The following processes are carried out by the power source circuit 57 and the CPU 50 in the PC 5. The CPU 50 carries out the processes in accordance with the control programs held in the ROM 51.

It is noted that the power source of the PC 5 is OFF when the processes illustrated in FIG. 14 are initiated.

The power source circuit 57, which is active even when the power source is OFF, judges whether it has received the power activation signal from an administration apparatus 4 (S701).

When no power activation signal has been received (S701: NO), the processes are terminated.

When the power activation signal has been received (S701: YES), the power source circuit 57 turns on the power source (S702).

The CPU 50 and other components in the PC 5 thus become active.

The CPU 50, which is now active, inquires about commands to be executed by the CPU 50 itself (S703).

For example, the CPU 50 inquires of an administration apparatus 4 about commands, and an administration apparatus 4 transmits the commands for the PC 5 held therein and ready to be transmitted, if any, to the PC 5.

The PC 5 stores the received commands.

The CPU 50 checks the stored commands and judges whether the stored commands include a command that disables the restoring (S704).

When the stored commands include a command that disables the restoring (S704: YES), the CPU 50 disables the restoring (S705).

After the restoring has been disabled, or when the stored commands do not include any command that disables the restoring (S704: NO), the CPU 50 checks the stored commands and judges whether the stored commands include a command that performs license authentication (S706).

When the stored commands include a command that performs license authentication (S706: YES), the CPU 50 sends a license authentication request to an authentication server 1 (S707).

The CPU 50 judges whether an authentication key 6 has been received from an authentication server 1 (S708).

When an authentication key 6 has been received (S708: YES), the CPU 50 decrypts the received authentication key 6 (S709) and stores it (S710).

As a result, the CPU 50 can be assigned a license of the installed software (OS) and execute the software.

After an authentication key 6 has been stored or when the stored commands do not include any command that performs license authentication (S706: NO), the CPU 50 checks the command stored in S703 and judges whether the stored commands include a command that enables the restoring (S711).

When the stored commands include a command that enables the restoring (S711: YES), the CPU 50 enables the restoring (S712).

After the restoring has been enabled or when the stored commands do not include any command that enables the restoring (S711: NO), the CPU 50 reports the completion of the following processes to an administration apparatus 4: the process of disabling the restoring, the process of performing the license authentication, and the process of enabling the restoring (S713).

The CPU 50 then transmits the client information, such as the authenticated date when the license authentication was performed, to an administration apparatus 4 (S714).

The CPU 50 then checks the commands stored in S703 and judges whether the stored commands includes a command that performs power source control (S715).

When the stored commands do not include any command that performs power source control (S715: NO), the CPU 50 keeps the power source ON, which was turned on in S702, and terminates the processes.

When the stored commands include a command that performs power source control (S715: YES), the CPU 50 or the power source circuit 57 controls the power source based on the command (S716).

For example, the power source circuit 57 turns off the power source, or temporarily turns off the power source and then turns it on again (restarts the power source).

The processes are then terminated.

As described above, in the data providing system disclosed in the present application, since the HDD 53 in each of the PCs 5, which stores an authentication key 6 necessary for the OS, undergoes a restoration process at a given timing, the data stored in the HDD 53 may be deleted in some cases in the restoration process.

When it is necessary to prevent the data from being deleted in the restoration process, the restoring may be disabled when a request for an authentication key 6 is sent to an authentication server 1. In this way, the possibility that the stored authentication key 6 is deleted in the restoration process can be effectively eliminated.

Further, enabling the restoring and turning off the power source after the license authentication has been completed allows a user to use the PC 5 with the restoring enabled when the PC 5 is started next time.

For example, while in the above description, an administration apparatus 4 enables the restoring of each of the PCs 5 after the license authentication has been completed, the restoring may be enabled after the PC 5 has received an authentication key 6.

In this case, even when the PC 5 is disconnected from an administration apparatus 4 due to a communication error or other reasons, there is no concern that the PC 5 is left with the restoring disabled.

Alternatively, each of the PCs 5 may be automatically turned off after the license authentication has been completed.

In this case, the PC 5 can be reliably turned off, whereby unnecessary power consumption can be reduced in some cases.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A terminal apparatus comprising:
a requester that requests data used for installed software from an external apparatus;
a receiver that receives the data requested by the requester;
a storage unit that stores the data received by the receiver;
a restoring unit that restores the storage unit to the state at an arbitrary point of time; and
a restoration controller that enables or disables the restoration operation of the restoring unit,
wherein the storage unit stores the data that is requested by the requester and received by the receiver after the restoration controller disables the restoration operation of the restoring unit,
the restoration controller enables the restoration operation of the restoring unit after the data received by the receiver is stored in the storage unit, and
the restoring unit restores the storing unit to the state at a point of time when or after the restoration controller enables the restoration operation.

2. A computer program product embodied in a computer readable medium, the computer program product being usable with a data providing system comprising:
a terminal apparatus comprising:
a communication unit that sends and receives data;
a storage unit that stores the received data; and
a restoring unit that restores the storage unit at a given timing to the state at an arbitrary point of time,
the terminal apparatus using the data stored in the storage unit to execute installed software;
a server that communicates with the terminal apparatus and stores data used for the software; and
a restoration control apparatus that communicates with the terminal apparatus and disables the restoration operation of the restoring unit,
the computer program product containing computer executable instructions that cause:
the restoration control apparatus to perform a transmission process of transmitting a disable signal to the terminal apparatus when the restoration operation of the restoring unit is disabled,
the terminal apparatus to perform a disable process of disabling the restoration operation of the restoring unit when the disable signal is received, and a request process of requesting the data from the server after the restoration operation is disabled in the disable process,
the server to perform a transmission process of transmitting the data requested by the terminal apparatus to the terminal apparatus, and
the terminal apparatus to perform an enable process of enabling the restoration operation of the restoring unit when the data is received from the server, and a restoration process of restoring at an arbitrary timing the storage unit to the state at a point of time when or after the restoring unit is enabled.

3. The computer program product according to claim 2,
wherein the server stores an authentication key that allows the software to be executed, and the request process carried out in the terminal apparatus requests an authentication key from the server,
the computer program product further containing computer executable instructions that cause the terminal apparatus to perform an execution process of executing the software when an authentication key is stored in the storage unit.

4. The computer program product according to claim 3,
wherein an authentication key is effective for a certain period,
the computer program product further containing computer executable instructions that cause the terminal apparatus to perform a necessity judgment process of judging whether the effective period of an authentication key has been expired, and
a termination process of terminating the execution of the software when the effective period has been judged expired in the necessity judgment process.

5. The computer program product according to claim 2,
the computer program product further containing computer executable instructions that cause the restoration control apparatus to perform a time judgment process of acquiring the last time when the terminal apparatus requested the data and judging whether a given period has elapsed since the acquired time,
wherein the disable signal transmission process carried out in the restoration control apparatus transmits the disable signal when it is judged in the time judgment process that a given period has elapsed since the last time when the terminal apparatus requested the data.

6. The computer program product according to claim 2,
the computer program product further containing computer executable instructions that cause the terminal apparatus to perform a necessity judgment process of judging whether the restoring unit needs to perform restoration when the data is received from the server,
wherein the restoration operation enabling process carried out in the terminal apparatus enables the restoration operation of the restoring unit when it is judged in the necessity judgment process that the restoration is necessary.

7. The computer program product according to claim 2,
the computer program product further containing computer executable instructions that cause the terminal apparatus to perform a switching process of turning on and off a power source, and
an external signal receiving process of receiving an external signal irrespective of whether the power source is ON or OFF,
wherein the disable signal transmission process carried out in the restoration control apparatus transmits the disable signal after an activation signal that switches the state of the power source to ON is transmitted to the terminal apparatus when the power source of the terminal apparatus is OFF,
the external signal receiving operation carried out in the terminal apparatus receives the activation signal, and
the switching process carried out in the terminal apparatus switches the power source to ON when the activation signal is received in the external signal receiving process.

8. The computer program product according to claim 6,
wherein the switching process carried out in the terminal apparatus turns off the power source after the enabling process enables the restoration operation.

9. A data providing method being usable with a terminal apparatus comprising:
a requester that requests data used for installed software from an external apparatus;
a receiver that receives the data requested by the requester;
a storage unit that stores the data received by the receiver;
a restoring unit that restores the storage unit to the state at an arbitrary point of time; and
a restoration controller that enables or disables the restoration operation of the restoring unit,
the method comprising:
causing the storage unit to store the data that is requested by the requester and received by the receiver after the restoration controller disables the restoring unit,
causing the restoration controller to enable the restoration operation of the restoring unit after the data received by the receiver is stored in the storage unit, and
causing the restoration controller to restore the storing unit to the state at a point of time when or after the restoration controller enables the restoration operation.

10. A computer readable medium storing a computer program being usable with a computer that comprises:
a requester that requests data used for installed software;
a restoring unit that restores a storage unit that stores the data that is requested by the requester and acquired to the state at an arbitrary point of time; and
a restoration controller that enables or disables the restoration operation of the restoring unit,
the computer program for causing the computer to perform:
a storing process of storing the data that is requested by the requester and received by the receiver after the restoration controller disables the restoration operation of the restoring unit,
an enabling process of enabling the restoration operation of the restoring unit after the data received by the receiver is stored in the storage unit, and
a restoration process of restoring the storing unit by using the restoring unit to the state at a point of time when or after the restoration controller enables the restoration operation.

11. A data restoring method comprising:
controlling with a micropocessor a storing of data that is requested and received by the receiver after a controller disables a restoring; and
enabling a restoring after the data received by the receiver is stored in the storage unit.
